(19) United States
(12) Patent Application Publication
(10) Pub. No.: US 2003/0055719 A1
(43) Pub. Date: Mar. 20, 2003

(54) Remote participation and voting in a meeting

(76) Inventor: Christopher T. Faigle, Richmond, VA (US)

Correspondence Address: BAKER & MCKENZIE, 805 THIRD AVENUE, NEW YORK, NY, 10022, US

(21) Appl. No.: 09/957,324

(22) Filed: Sep. 20, 2001

(51) Int. Cl. G06F 17/60

(52) U.S. Cl. 705/12

(57) ABSTRACT

A system and method for non-attending members of a group to remotely participate in a voting meeting through a network such as the Internet. The system includes authentication, broadcast and voting computers which work together to authenticate the online members, broadcasts the meeting to the authenticated members, and receive votes from the authenticated online members. The present system provides the advantage of allowing voters to virtually attend the meeting and vote on any issues that are presented at the meeting.

### FIELD OF THE INVENTION

The present invention relates to data processing systems, and in particular, online voting systems.

### BACKGROUND OF THE INVENTION

Over the years, many computerized voting systems have been developed in an effort to automate the process of collecting and counting votes. One system described in U.S. Pat. No. 4,774,665 includes a number of precinct workstations for reading, counting and storing votes, and a central district workstation for controlling the programming of the precinct stations and for reading and tallying stored precinct votes.

Another system described in U.S. Pat. No. 5,218,528 integrates the stages of registering and certifying voters, and collecting their votes. In that system, a computer station accesses a database to verify that a voter is eligible to vote. Vote entry stations provide a graphic interface for permitting the voter to enter votes. A vote entry controller activates and monitors the vote entry stations to prevent unauthorized voting. Votes may be collected at either the vote entry stations or at the vote entry controller. Votes collected at the vote entry stations are downloaded to the vote entry controller, which enhances security by providing a means to compare votes collected at one point in the system with votes collected at another point.

Yet another system described in U.S. Pat. No. 6,081,793 provides for online voting by remotely located voters through a computer network such as the Internet.

However, when voting takes place at a meeting such as in a shareholder meeting, many remotely located voters may wish to participate in the discussion of issues to be voted on either by listening to or viewing the meeting in progress. Conventional voting systems do not allow such participation.

Therefore, it is desirable to provide a system and method for allowing remotely located voters to participate and vote in a meeting.

### SUMMARY OF THE INVENTION

According to the principles of the present invention, there is provided a system and method for non-attending members of a group to remotely participate in a voting meeting. The system includes authentication, broadcast and voting computers. The authentication computer authenticates the identities of online members to ensure that they are eligible to participate in the meeting. Once authenticated, the broadcast computer broadcasts the meeting to the authenticated online members while the meeting is in progress. Preferably, the meeting is broadcast through a computer network such as the Internet to which the members' computers are connected. When voting is about to take place at the meeting, the voting computer transmits a vote request and receives the votes from the authenticated online members. The voting result is then determined based on the received votes.

As can be appreciated, the present system allows voters to virtually attend a voting meeting and vote on any issues that are presented at the meeting. As a result, the remotely located voters can more fully participate in the meeting.

### BRIEF DESCRIPTION OF THE DRAWINGS

FIG. 1 is a diagram of an exemplary system for remote participation of voters at a meeting according to the present invention.

FIG. 2 is a flow diagram of a method for voters to remotely participate and vote in a meeting according to the present invention.

FIG. 3 is a flow diagram of a process for qualifying members wishing to participate in the meeting.

### DETAILED DESCRIPTION OF THE INVENTION

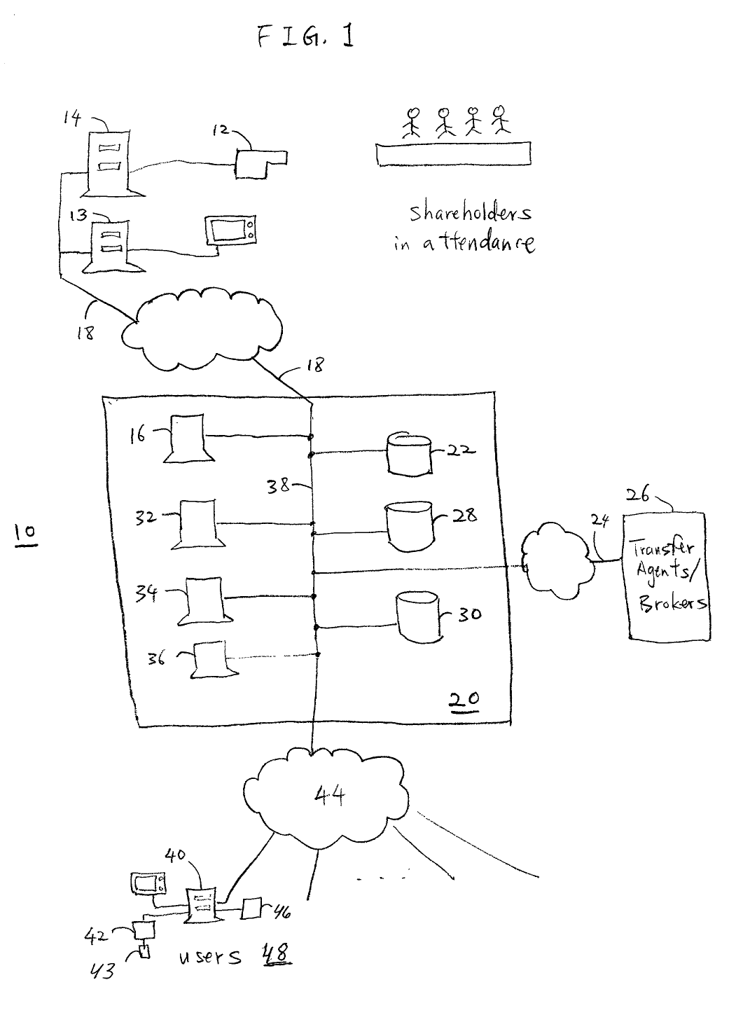

The present invention is a system and method for members of a group to remotely participate and vote in a meeting. FIG. 1 illustrates a diagram of an exemplary system 10 for remote participation of members where the members are shareholders participating in a shareholder meeting. A capture device 12, preferably a video camera, is operable to capture a meeting in progress. In the embodiment shown, the captured signal includes both video and audio signals. An encryption server 14 connected to the capture device 12 converts the captured signal into a data stream and encrypts the data stream. The server 14 is connected to a decryption server 16 over a link 18 which can be an Internet, Intranet, VPN (virtual private network) or the like.

A service provider 20 houses the decryption server 16, one or more broadcast servers 32, authentication server 34 and voting server 36 which are all connected to each other through a bus 38. A shareholder database 22, audio/video storage 28 and authentication database 30 are also all connected to the bus 38.

The shareholder database 22 stores identification and ownership information of the holders such as the number of shares owned by each shareholder. The ownership information is updated through a link 24, either in real-time or on a set schedule, from agents 26. The agents 26 may be transfer agents or clearing brokers that maintain shareholder records.

The authentication database 30 stores authentication information that are required to verify the authenticity of the shareholders requesting remote participation in the meeting. The types of authentication information that are stored can vary depending on the authentication technology used. For example, if a smart card technology is used, the service provider 20 would have issued a smart card 43 to each eligible shareholder according to the information obtained from the shareholder database 22. In that case, the authentication database 30 would contain the shareholders' cryptographic keys such as symmetric keys, or public/private keys that allow verification of the smart cards 43. If a biometric technology is used, the database 30 would store for example reference fingerprint information of the shareholders.

The authentication server 34 authenticates the shareholder identity based on that shareholder's authentication record stored in the database 30, and verifies the shareholder's ownership of company shares. The server 34 is also responsible for providing one or more cryptographic keys to the holder's computer 40 for secure communication and for decryption of the data stream of the captured signal.

In the embodiment shown, computers 40 of the remotely located shareholders 48 interact with various servers 32-36 through a computer network such as the Internet 44. Authentication devices such as a smart card reader 42 and/or a biometric reader 46 connected to the computer 40 are used to authenticate the identity of the shareholder as discussed in more detail later herein.

The video server 16 decrypts the encrypted data stream being received through the link 18 and stores it in an audio/video storage 28 for concurrent broadcasting and for later viewing by eligible shareholders who may have missed the meeting. Alternatively, the data stream can be stored encrypted in audio/video storage 28. The broadcast server 32 retrieves the stored data stream from the storage 28, encrypts it with a cryptographic key and broadcasts the encrypted data stream to the shareholders 48.

When voting is required during the course of the meeting, the voting server 36 securely transmits voting details to the shareholders 48 and receives responses. The server 36 then transmits them to a voting server 13 located at the meeting. The server 13 also collects votes from the shareholders attending the meeting and stores proxy votes. The server 13 combines all votes and displays the total result at the meeting. In an alternative embodiment, one server located at the meeting functions as both the encryption server 14 and the voting server 13.

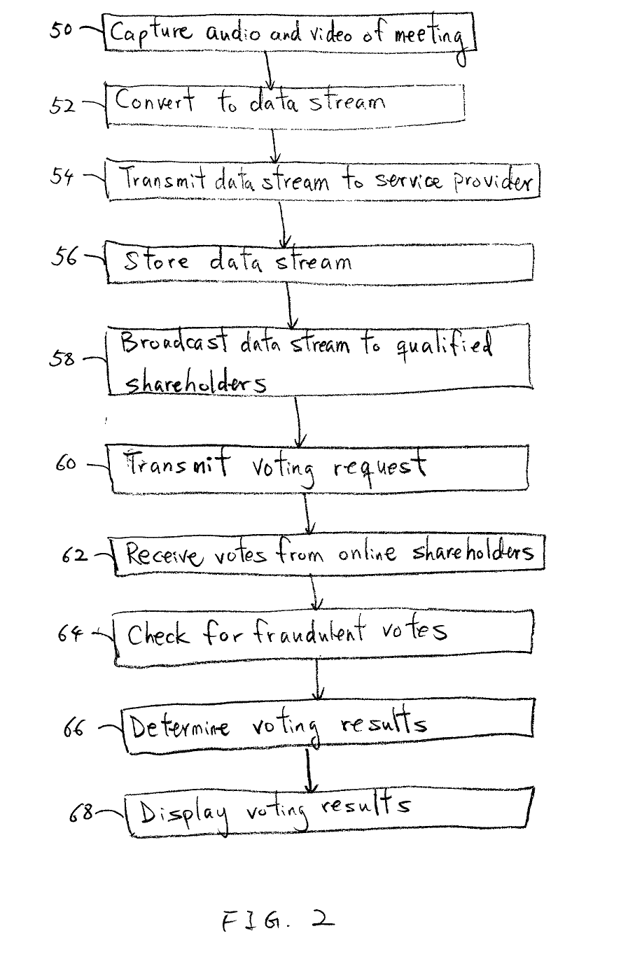

FIG. 2 is a flow diagram of a method for shareholders to remotely participate in a shareholder meeting, including viewing the meeting in progress and voting. Portions of the computer code implementing the method are stored in various servers of FIG. 1.

In step 50, the capture device 12 captures audio and preferably video of the meeting in progress and transmits the captured signal to the encryption server 14. In step 52, the captured signal is digitized and converted into a data stream. In a preferred embodiment, the data stream is in a streaming media format such that it can be viewed in real-time by remotely located shareholders 48.

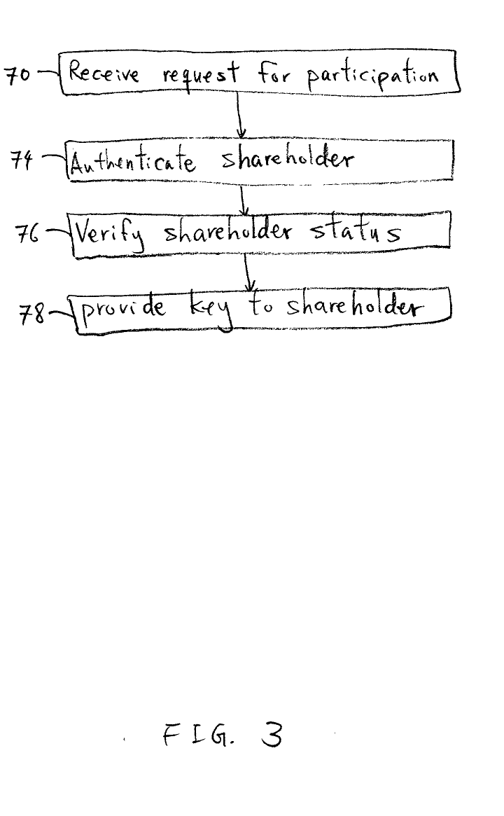

In step 54, the encryption server 14 transmits the encrypted data stream over the link 18 to the decryption server 16 located at the site of the meeting service provider 20. In step 56, the data stream is decrypted by the decryption server 16 and stored in the storage 28. In step 58, the stored data stream is retrieved by the broadcast server 32, re-encrypted and the re-encrypted signal is broadcast to “qualified” shareholders through the Internet 44. The qualification process is illustrated below with reference to FIG. 3.

Referring to FIG. 3, in step 70, the authentication server 34 receives a request for participation from a shareholder 38 wishing to remotely participate in the meeting through the shareholder computer 40. Steps 74 and 76 determine whether the shareholder is qualified to participate in the meeting.

In step 74, the authentication server 34 authenticates the shareholder 38. In the embodiment shown in FIG. 1, the authentication process is performed in the following manner. In response to the shareholder's request for access, the server 34 retrieves from the authentication database 30 the authentication record corresponding to the shareholder 38. The authentication record includes the shareholder identification information and a cryptographic key needed to decrypt messages sent by a smart card 43 owned by the shareholder 38. Concurrently, the server 34 requests the shareholder to insert the smart card 43 into the reader 42.

When the smart card 43 is inserted, the shareholder 38 enters a shareholder identifier such as a PIN (personal identification number) through the computer 40. The smart card 43 verifies the PIN against its own stored version. Once verified, the smart card 43 communicates with the authentication server 34 using a challenge/response authentication protocol well-known in the art so that identities of both the shareholder 38 and the server 34 are mutually authenticated.

Alternatively, if a biometric device such as a fingerprint reading device 46 is used, the authentication record stored in the storage 30 includes the shareholder's reference fingerprint which is compared against a fingerprint of the shareholder which has been scanned by the fingerprint reading device. Other alternative identification devices such as voice or retinal eye scanning devices can also be used.

Once the shareholder is authenticated in step 74, the authentication server 34 in step 76 verifies the shareholder status in terms of ownership of at least one share of the company to ensure that that shareholder is eligible to vote at the meeting. Verification of the shareholder is done by retrieving shareholder information from the shareholder database 22.

If the shareholder 38 is determined to be qualified to participate under steps 74 and 76, then the server 34 in step 78 transmits one or more cryptographic keys to the shareholder 38 for secure communication between the provider 20 and the shareholder's computer 40. The cryptographic keys are used by the computer 40 to decrypt the encrypted data stream signal broadcast by the broadcast server 32 and to encrypt voting responses that are transmitted to the voting server 36.

Referring back to FIG. 2, in step 60 when the meeting reaches a point at which a vote is to be taken, the voting server 36 is pre-programmed with voting questions and all possible responses thereto. Alternatively, the voting questions can be created by the voting server 36 in real-time or some voting questions can be pre-programmed and other voting questions created in real-time. The server 36 securely transmits the necessary voting information to the qualified shareholders 48 and requests their responses.

In step 62, the server 36 receives the voting responses from the qualified shareholders which are then transmitted to the onsite voting server 13 through the link 18. At the same time, the server 13 receives the voting responses from the shareholders in attendance. In step 64, the voting server 36 checks for fraudulent votes among the votes cast by proxy, by qualified online shareholders, and by shareholders in attendance. In one embodiment, fraud checking involves ensuring that there are no duplicate votes and the number of votes cast corresponds to the record stored in the shareholder database 22. In step 66, the server 13 combines all shareholder votes and determines the voting results. In step 68, the server 13 15displays the result at the meeting.

As discussed above, computer code that performs the user's side of the authentication and verification steps 74, 76 can be downloaded, for example as preferably JAVA applets to be run by a browser, at the time the shareholder requests access in step 70, or downloaded prior to the request for access and installed in the shareholder's computer 40.

From the foregoing, it will be appreciated that, although specific embodiments of the invention have been described herein for purposes of illustration, various modifications may be made without deviating from the spirit and scope of the invention. For example, while the invention has been described with reference to shareholders, the principles of the invention can be applied to remote participation of any members of a group conducting a meeting such as employees of a company, voters in an election, focus group for a motion picture film preview, product screening or the like. Accordingly, the present invention is not limited except as by the appended claims.

What is claimed is:

1. A method for members to remotely participate in a voting meeting, comprising:
broadcasting through a computer network the voting meeting to a plurality of authenticated online members;
transmitting a vote request to the plurality of authenticated online members while the voting meeting is in progress;
receiving a plurality of votes from the plurality of authenticated online members in response to the vote request; and
determining a voting result according to the received plurality of votes.

2. The method according to claim 1, further comprising:
receiving a member identifier from each online member of the plurality of authenticated online members; and
authenticating the each online member if the received member identifier corresponds to a stored identifier.

3. The method according to claim 2, further comprising:
transmitting a cryptographic key to the each online member for secure communication.

4. The method according to claim 1, further comprising:
authenticating each online member of the plurality of authenticated online members through a smart card issued to the each online member.

5. The method according to claim 1, further comprising:
authenticating each online member of the plurality of authenticated online members through a biometric device.

6. A method for shareholders of a company to remotely participate in a shareholder meeting, comprising:
capturing a company meeting in progress;
broadcasting through a computer network the captured meeting to a plurality of authenticated online shareholders of the company, the broadcasting being performed concurrently with capturing of the company meeting;
transmitting a vote request to the plurality of authenticated online shareholders while the meeting is in progress;
receiving a plurality of votes from the plurality of authenticated online shareholders in response to the vote request; and
determining a voting result according to the received plurality of votes.

7. The method according to claim 6, wherein the step of determining a voting result comprises:
receiving proxy votes;
receiving votes from shareholders in attendance; and
combining the received proxy votes and received votes.

8. The method according to claim 6, further comprising:
authenticating the plurality of online shareholders through smart cards issued to the plurality of online shareholders.

9. The method according to claim 6, further comprising:
receiving a shareholder identifier from each online shareholder of the plurality of online shareholders; and
authenticating the each online shareholder if the received shareholder identifier corresponds to a stored identifier.

10. The method according to claim 9, further comprising:
transmitting a cryptographic key to the each online shareholder for secure communication.

11. The method according to claim 9, further comprising:
receiving a biometric identifier from the each online shareholder;
authenticating the each online shareholder if the received biometric identifier corresponds to a stored biometric identifier.

12. The method according to claim 11, further comprising:
transmitting a cryptographic key to the each authenticated online shareholder for secure communication.

13. The method according to claim 6, further comprising:
verifying ownership of at least one share of the company by each authenticated online shareholder of the plurality of online shareholders.

14. The method according to claim 6, further comprising:
receiving identifiers of shareholders voting at the meeting; and
verifying that the received shareholder identifiers do not include any authenticated online shareholders.

15. The method according to claim 6, wherein a shareholder database continuously updates ownership status of company shares, the method further comprising:
receiving a shareholder identifier from each online shareholder of the plurality of online shareholders;
authenticating the each online shareholder if the received shareholder identifier corresponds to a stored identifier; and
verifying from a shareholder database that the each online shareholder owns at least one share of the company.

16. The method according to claim 15, wherein verifying from the shareholder database is performed prior to determining the voting result and after authenticating.

17. A system for members to remotely participate in a voting meeting, comprising:
an authentication computer operable to authenticate the identities of a plurality of online members;
a broadcast computer operable to broadcast a voting meeting to the plurality of authenticated online members while the meeting is in progress; and
a voting computer operable to transmit a vote request to and receive a plurality of votes from the plurality of authenticated online members, and to determine a voting result based on the plurality of received votes.

18. The system according to claim 17, further comprising:
a capture device that converts audio and video of the meeting in progress into a digital signal for transmission to the broadcast computer.

19. The system according to claim 17, wherein the authentication computer receives a member identifier from each online member of the plurality of online members and authenticates the each online member if the received member identifier corresponds to a stored identifier.

20. The system according to claim 17, wherein the authentication computer receives a biometric identifier from each online member of the plurality of online members and authenticates the each online member if the received biometric identifier corresponds to a stored biometric identifier.

21. The system according to claim 17, wherein the authentication computer authenticates each online member plurality of online members using a smart card issued to the each online member.

22. A system for shareholders of a company to remotely participate in a shareholder meeting, comprising:
an authentication computer operable to authenticate the identities of a plurality of online shareholders of a company;
a broadcast computer operable to broadcast a shareholder meeting of the company to the plurality of authenticated online shareholders while the meeting is in progress; and
a voting computer operable to transmit a vote request to and receive a plurality of votes from the plurality of authenticated online shareholders, and to determine a voting result based on the plurality of received votes.

23. The system according to claim 22, further comprising:
a capture device that converts audio and video of the meeting in progress into a digital signal for transmission to the broadcast computer through a computer network.

24. The system according to claim 23, further comprising:
an encryption computer operable to encrypt the digital signal; and
a decryption computer operable to decrypt the encrypted digital signal received through the computer network.

25. The system according to claim 24, wherein the broadcast computer encrypts the decrypted digital signal prior to transmission to the plurality of authenticated online shareholders.

26. The system according to claim 22, wherein the authentication computer receives a shareholder identifier from each online shareholder of the plurality of online shareholders and authenticates the each online shareholder if the received shareholder identifier corresponds to a stored identifier.

27. The system according to claim 22, wherein the authentication computer receives a biometric identifier from each online shareholder of the plurality of online shareholders and authenticates the each online shareholder if the received biometric identifier corresponds to a stored biometric identifier.

28. The system according to claim 22, wherein the authentication computer authenticates each online shareholder of the plurality of online shareholders through a smart card issued to the each online shareholder.

29. The system according to claim 22, wherein the voting computer verifies ownership of at least one share of the company by each online shareholder of the plurality of online shareholders.

30. The system according to claim 22, wherein the voting computer receives the plurality of votes from the shareholders attending the meeting and combines all received votes to determine the voting result.

31. The system according to claim 29, wherein the voting computer receives identifiers of shareholders attending the meeting and verifies that the received shareholder identifiers do not include any authenticated online shareholders.
